(19) United States
(12) Patent Application Publication
(10) Pub. No.: US 2005/0229351 A1
(43) Pub. Date: Oct. 20, 2005

(54) Windshield wiper blade assembly and apparatus comprising same

(76) Inventor: Robert P. McMullen, Greenville, MI (US)

Correspondence Address: SIMON, GALASSO & FRANTZ PLC., P.O. Box 26503, Austin, TX, 78755-0503, US

(21) Appl. No.: 11/026,239

(22) Filed: Dec. 30, 2004

Related U.S. Application Data
(60) Provisional application No. 60/533,589, filed on Dec. 31, 2003.

(51) Int. Cl. B60S 1/46; B60S 1/54; B60S 1/38

(52) U.S. Cl. 15/250.04; 15/250.361

(57) ABSTRACT

A windshield wiper apparatus comprises a forced air supply device, a windshield wiper blade assembly and an air delivery tube. The windshield wiper blade assembly includes an air duct having a plurality of air outlets and an air inlet. The air delivery tube is connected between the forced air supply device and the air inlet of the windshield wiper blade assembly. The forced air supply device is configured for supplying heated air to the windshield wiper blade assembly. The windshield wiper blade assembly includes a windshield wiper blade housing and the windshield wiper blade housing comprises the air duct. The windshield wiper blade housing includes a plurality of blade-carrying segments and a first one of said segments is flexibly attached to a second one of said segments.

### CROSS REFERENCE TO RELATED APPLICATIONS

This application claims priority to co-pending United States Provisional Patent Application having Ser. No. 60/533,589 filed Dec. 31, 2003 entitled “Ice Free Wipers”, having a common applicant herewith and being incorporated herein in its entirety by reference.

### FIELD OF THE DISCLOSURE

The disclosures made herein relate generally to vehicle windshield wiper apparatuses and, more particularly, to windshield wiper apparatuses configured for use in cold climates.

### BACKGROUND

A windshield wiper apparatus is a valuable safety apparatus for a vehicle such as a car or truck. Without effective performance of such a windshield wiper apparatus, visibility is generally dramatically impaired when driving a vehicle in inclement conditions. Examples of such inclement weather conditions include rain, snow, sleet, and fog.

Temperatures below freezing, whether ambient temperature or wind-induced temperature, can present especially dangerous driving conditions. When accompanied by snow or rain, such below freezing temperatures can result in ice forming on the windshield of a car. Additionally, even in dry conditions, applying typical windshield washing solutions using a vehicle's windshield wash system can lead to an immediate icing of the windshield and wiper blades, particularly when the interior of the vehicle is near or below freezing temperatures.

Regardless of the source of liquid, such formation of ice on a windshield impairs visibility and adversely impacts the performance of a conventional windshield wiper apparatus of a vehicle. The adverse impact on the performance of the vehicle's windshield wiper apparatus compounds the undesirable condition of ice forming on the vehicle's windshield and wiper blades. The end result is either an exceedingly dangerous driving situation or the inconvenience of having to manually remove the ice from the windshield and wiper blades.

Conventional windshield wiping apparatuses that do not include a heating device are severely limited in that they do not include any means for counteracting below freezing temperatures on the formation of ice. Some conventional windshield wiping apparatuses do have heating devices that are intended to remedy the formation of ice on a windshield. However, conventional windshield wiping apparatuses that comprise a heating device either only heat the windshield wiper blade assembly itself (e.g., internal heating via resistive element within the windshield wiper blade) or attempt to heat the windshield surface by radiant heating means. Internal heating of the windshield wiper blade assembly may provide limited ability to melt ice on the wider blade but is severely limited in its ability to melt ice formed on the windshield. Radiant heating means are limited in that their heating capacity is limited for this application and is adversely impacted by thermal cooling effect associated with movement of the windshield wiper blade assembly and/or vehicle.

Therefore, a windshield wiper apparatus that overcomes shortcomings associated with conventional windshield wiper apparatuses would be advantageous, useful and novel.

### SUMMARY OF THE DISCLOSURE

The inventive disclosures made herein relate to a windshield wiper apparatus for a vehicle that overcomes shortcomings associated with conventional approaches windshield wiper apparatuses. More specifically, a windshield wiper apparatus in accordance with the inventive disclosures made herein provides heating of the windshield wiper blade assembly, the windshield and applied cleaning solution. Through such heating, the formation of ice on the vehicle's windshields is effectively counteracted whereby formed ice rapidly melts and/or liquid that comes into contact with the windshield and/or wiper blade assembly does not readily freeze. Additionally, the heat serves to maintain intended compliance of the windshield wiper blade(s). To this end, a windshield wiper apparatus in accordance with the inventive disclosures made herein allows for the windshield to be cleaned of contaminants (e.g., dirt, salt, oil, etc.) and ice for providing improved safety and wiper performance in driving conditions where the temperature is below freezing.

In one embodiment of the inventive disclosures made herein, a windshield wiper blade assembly comprises a windshield wiper blade housing and a windshield wiper blade. The windshield wiper blade housing has an air duct formed therein. The air duct includes at least one air outlet. The windshield wiper blade is attached to the windshield wiper blade housing with a wiping edge of the windshield wiper blade positioned adjacent the at least one air outlet.

In another embodiment of the inventive disclosures made herein, a windshield wiper blade housing comprises a windshield wiper arm mounting member, a windshield wiper blade mounting structure and an air duct. The windshield wiper blade mounting structure is configured for having a windshield wiper blade attached thereto. The air duct includes a plurality of air outlets and configured for having air forced therethrough. One or more of the air outlets are orientated for directing the forced air toward an edge of the attached wiper blade.

In another embodiment of the inventive disclosures made herein, a windshield wiper apparatus comprises a forced air supply device, a windshield wiper blade assembly and an air delivery tube. The windshield wiper blade assembly includes an air duct having a plurality of air outlets and an air inlet. The air delivery tube is connected between the forced air supply device and the air inlet of the windshield wiper blade assembly.

Turning now to specific embodiments of the inventive disclosures made herein, in at least one embodiment of the inventive disclosures made herein, the windshield wiper blade housing includes a windshield wiper blade receiving recess formed therein and the windshield wiper blade protrudes from within the windshield wiper blade receiving recess.

In at least one embodiment of the inventive disclosures made herein, the air duct includes a plurality of air outlets and one or more of the air outlets are positioned along a perimeter of the windshield wiper blade receiving recess.

In at least one embodiment of the inventive disclosures made herein, the windshield wiper blade housing includes a plurality of blade-carrying segments and a first one of said segments is flexibly attached to a second one of said segments.

In at least one embodiment of the inventive disclosures made herein, a windshield washing solution spray nozzle is attached to the windshield wiper blade housing.

In at least one embodiment of the inventive disclosures made herein, the forced air supply device is configured for supplying heated air to the windshield wiper blade assembly.

In at least one embodiment of the inventive disclosures made herein, the forced air supply device includes a heating element from which heat is transferred to air supplied to the windshield wiper blade assembly.

These and other objects and embodiments of the inventive disclosures made herein will become readily apparent upon further review of the following specification and associated drawings.

### BRIEF DESCRIPTION OF THE DRAWINGS

FIG. 1 depicts an embodiment of a windshield wiper apparatus in accordance with the inventive disclosures made herein.

FIG. 2 depicts a fragmentary tip view of the windshield wiper apparatus depicted in FIG. 1.

FIG. 3 is a cross sectional view taken along the line 3-3 in FIG. 1.

### DETAILED DESCRIPTION OF THE DRAWINGS

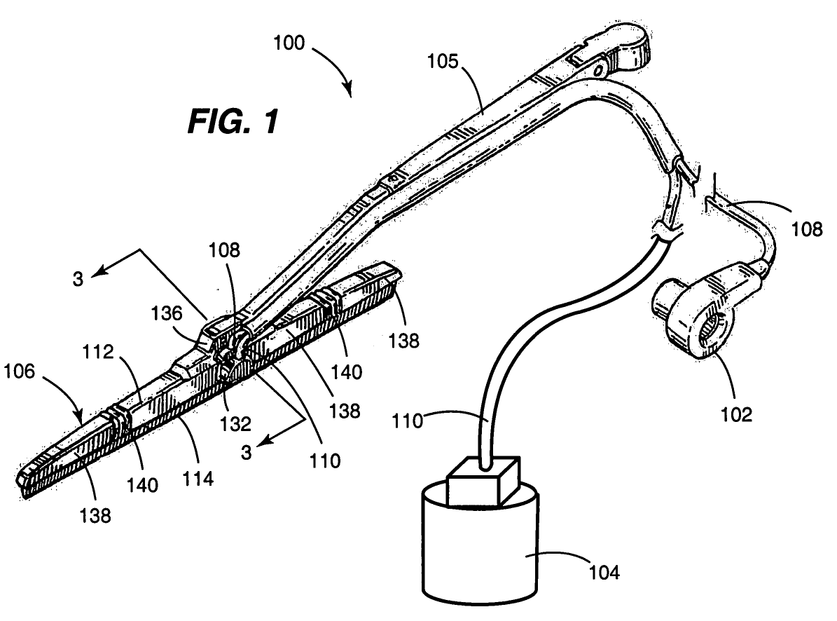

FIG. 1 depicts an embodiment of a windshield wiper apparatus 100 in accordance with the inventive disclosures made herein. The windshield wider apparatus 100 includes a forced air supply device 102, a windshield wash solution supply device 104, a windshield wiper blade assembly arm 105, a windshield wiper blade assembly 106, an air delivery tube 108 and a solution delivery tube 110. The windshield wiper blade assembly arm 105 is attached at a first end to the windshield wiper blade assembly 106. A second end of the windshield wiper blade assembly arm 105 is configured for being attached to a windshield wiper motor assembly of a vehicle. Though the windshield wiper motor assembly of the vehicle and the windshield wiper blade assembly arm 105, the windshield wiper blade assembly 106 is movable across a surface of a windshield of the vehicle.

The air delivery tube 108 is connected between the windshield wiper blade assembly 106 and the forced air supply device 102 for enabling forced air to be delivered from the forced air supply device 102 to the windshield wiper blade assembly 106. The solution delivery tube 110 is connected between the windshield wiper blade assembly 106 and the windshield wash solution supply device 104 for enabling windshield wash solution to be delivered from the a windshield wash solution supply device 104 to the windshield wiper blade assembly 106. A blower unit with an attached electric motor is an example of the forced air supply device 102. In one embodiment, the forced air supply device 102 includes a heating element (e.g., a resistive heating element integral with the blower unit) from which heat is transferred to air supplied to the windshield wiper blade assembly 106. Optionally, the forced air supply device 102 may inject heated air from the passenger compartment or engine bay. A pump unit with an attached electric motor (e.g., a conventional automotive windshield wash pump assembly) is an example of the windshield wash solution supply device 104.

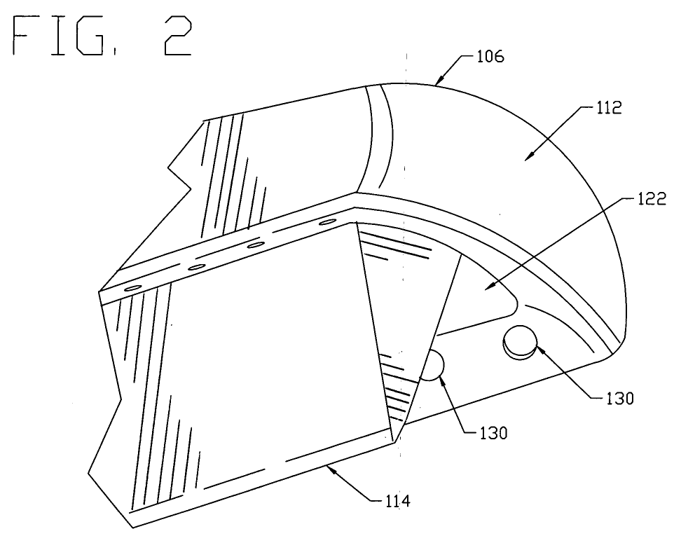

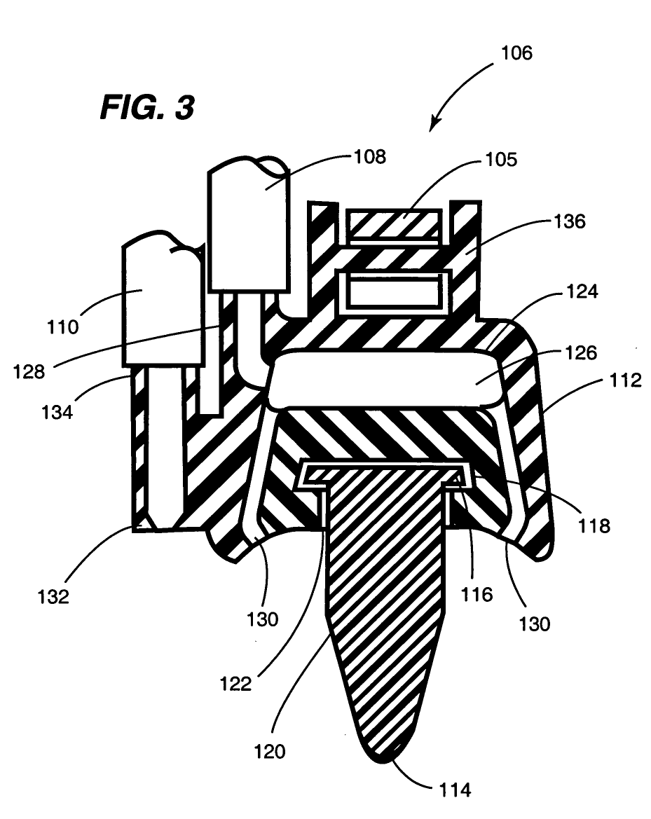

Referring now to FIGS. 1-3, the windshield wiper blade assembly 106 includes a windshield wiper blade housing 112 and a windshield wiper blade 114 attached to the windshield wiper blade housing 112. The windshield wiper blade 114 includes a flange portion 116 that is received within a mating slot 118 of the windshield wiper blade housing 112. For example, the windshield wiper blade housing 112 may include an opening at one of its ends for enabling access to the mating slot 118. A wiping edge portion 120 of the windshield wiper blade 114 protrudes from a windshield wiper blade receiving recess 122 of the windshield wiper blade housing 112.

The windshield wiper blade housing 112 includes an air duct 124 formed therein, which defines an internal air passage 126. Preferably, but not necessarily, the windshield wiper blade housing 112 is formed from a polymeric material using a process such as injection molding, extrusion, blow molding or rotational molding. To enable formation of the air passage 126, the windshield wiper blade housing 112 may be made in two of more mating pieces.

The air duct 124 extended substantially along the entire length of the windshield wiper blade housing 112. An air inlet 128 is attached to the air duct 124 for enabling forced air from the forced air supply device 102 to be supplied to the air duct 124 through the air delivery tube 108. The air duct 124 includes a plurality of air outlets 130 for enabling forced air from the forced air supply device 102 to be exhausted from the air duct 125 at positions adjacent the wiping edge portion 120 of the windshield wiper blade 114. Preferably, but not necessarily, at least a portion of the air outlets 130 are positioned along a perimeter of the windshield wiper blade receiving recess 122 and are orientated such that the forced air at least partially impinges upon the wiping edge portion 120 of the windshield wiper blade 114.

A windshield washing solution spray nozzle 132 is attached to the windshield wiper blade housing 112. Preferably, but not necessarily, the windshield washing solution spray nozzle 132 is integrally formed with the windshield wiper blade housing 112. The solution delivery tube 110 is connected to a solution inlet 134 of the windshield washing solution spray nozzle 132 for enabling windshield wash solution supplied from the windshield wash solution supply device 104 to be sprayed on to the windshield of the vehicle through the windshield washing solution spray nozzle 132.

The windshield wiper blade housing 112 includes a windshield wiper arm mounting member 136. The windshield wiper arm mounting member 136 is configured for having the windshield wiper blade assembly arm 105 attached thereto. A skilled person will appreciate known mounting members configured for having known configurations of windshield wiper blade assembly arms operably attached thereto.

The windshield wiper blade housing 112 includes a plurality of blade-carrying segments 138. Each one of the blade-carrying segments 138 is flexibly attached to each adjacent blade-carrying segment 138. In one embodiment, each one of the blade-carrying segments 138 are made from a relatively rigid material and a joint 140, which is made from a relatively flexible material, is connected between adjacent blade-carrying segments 138. Preferably, but not necessarily, the joint 140 includes an internal passage for providing continuity between respective portions of the air duct 124 of the blade-carrying segments 138. Accordingly, through the ability for the various blade-carrying segments 138 to exhibit relative movement, the windshield wiper blade housing 112 and the windshield wiper blade 114 may better follow a curvature of the vehicle's windshield.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosures made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A windshield wiper blade assembly, comprising:
a windshield wiper blade housing having an air duct formed therein, wherein the air duct includes at least one air outlet; and
a windshield wiper blade attached to the windshield wiper blade housing with a wiping edge of the windshield wiper blade positioned adjacent said at least one air outlet.

2. The windshield wiper blade assembly of claim 1 wherein:
the windshield wiper blade housing includes a windshield wiper blade receiving recess formed therein; and
the windshield wiper blade protrudes from within the windshield wiper blade receiving recess.

3. The windshield wiper blade assembly of claim 1 wherein:
the air duct includes a plurality of air outlets; and
at least a portion of said air outlets are positioned along a perimeter of the windshield wiper blade receiving recess.

4. The windshield wiper blade assembly of claim 1 wherein:
the windshield wiper blade housing includes a plurality of blade-carrying segments; and
a first one of said segments is flexibly attached to a second one of said segments.

5. The windshield wiper blade assembly of claim 1, further comprising:
a windshield washing solution spray nozzle attached to the windshield wiper blade housing.

6. The windshield wiper blade assembly of claim 1, further comprising:
a windshield washing solution spray nozzle attached to the windshield wiper blade housing;
wherein the windshield wiper blade housing includes a windshield wiper blade receiving recess formed therein;
wherein the windshield wiper blade protrudes from within the windshield wiper blade receiving recess;
wherein the air duct includes a plurality of air outlets;
wherein at least a portion of said air outlets are positioned along a perimeter of the windshield wiper blade receiving recess;
wherein the windshield wiper blade housing includes a plurality of blade-carrying segments; and
wherein a first one of said segments is flexibly attached to a second one of said segments.

7. A windshield wiper blade housing, comprising:
a windshield wiper arm mounting member;
a windshield wiper blade mounting structure configured for having a windshield wiper blade attached thereto;
an air duct including a plurality of air outlets and configured for having air forced therethrough, whereby at least a portion of said air outlets are orientated for directing said forced air toward an edge of said attached wiper blade.

8. The windshield wiper blade housing of claim 7, further comprising:
a windshield wiper blade receiving recess, wherein said attached wiper blade protrudes from within the windshield wiper blade receiving recess and wherein at least a portion of said air outlets are positioned along a perimeter of the windshield wiper blade receiving recess.

9. The windshield wiper blade housing of claim 7, further comprising:
a windshield washing solution spray nozzle.

10. The windshield wiper blade housing of claim 7 wherein:
the windshield wiper blade mounting structure includes a plurality of blade-carrying segments; and
a first one of said segments is flexibly attached to a second one of said segments.

11. The windshield wiper blade housing of claim 7, further comprising:
a windshield washing solution spray nozzle; and
a windshield wiper blade receiving recess;
wherein said attached wiper blade protrudes from within the windshield wiper blade receiving recess;
wherein at least a portion of said air outlets are positioned along a perimeter of the windshield wiper blade receiving recess;
wherein the windshield wiper blade mounting structure includes a plurality of blade-carrying segments; and
wherein a first one of said segments is flexibly attached to a second one of said segments.

12. A windshield wiper apparatus, comprising:
a forced air supply device;
a windshield wiper blade assembly including an air duct having a plurality of air outlets and an air inlet; and
an air delivery tube connected between the forced air supply device and the air inlet of the windshield wiper blade assembly.

13. The windshield wiper apparatus of claim 12 wherein the forced air supply device is configured for supplying heated air to the windshield wiper blade assembly.

14. The windshield wiper apparatus of claim 13 wherein the forced air supply device includes a heating element from which heat is transferred to air supplied to the windshield wiper blade assembly.

15. The windshield wiper apparatus of claim 12 wherein:
the windshield wiper blade assembly includes a windshield wiper blade housing;
the windshield wiper blade housing comprises the air duct;
the windshield wiper blade housing includes a plurality of blade-carrying segments; and
a first one of said segments is flexibly attached to a second one of said segments.

16. The windshield wiper apparatus of claim 15 wherein:
the windshield wiper blade housing includes a windshield wiper blade receiving recess formed therein;
the windshield wiper blade assembly includes a windshield wiper blade attached to the windshield wiper blade housing with a wiping edge of the windshield wiper blade positioned adjacent at least a portion of said air outlets;
the windshield wiper blade protrudes from within the windshield wiper blade receiving recess; and
at least a portion of said air outlets are positioned along a perimeter of the windshield wiper blade receiving recess.

17. The windshield wiper apparatus of claim 16, further comprising:
a windshield washing solution spray nozzle attached to the windshield wiper blade housing.

18. The windshield wiper apparatus of claim 16 wherein the forced air supply device is configured for supplying heated air to the windshield wiper blade assembly.

19. The windshield wiper apparatus of claim 18 wherein the forced air supply device includes a heating element from which heat is transferred to air supplied to the windshield wiper blade assembly.
